(19) United States
(12) Patent Application Publication
(10) Pub. No.: US 2025/0123901 A1
(43) Pub. Date: Apr. 17, 2025

(54) METHOD, ELECTRONIC DEVICE, AND PROGRAM PRODUCT FOR ALLOCATING RESOURCES

(71) Applicant: Dell Products L.P., Round Rock, TX (US)

(72) Inventors: Hailan Dong, Chengdu (CN); Chi Chen, Chengdu (CN); Changyue Dai, Chengdu (CN)

(21) Appl. No.: 18/514,105

(22) Filed: Nov. 20, 2023

(30) Foreign Application Priority Data
Oct. 12, 2023 (CN) 202311325126.1

(51) Int. Cl. G06F 9/50

(52) U.S. Cl. CPC G06F 9/5083; G06F 9/5016; G06F 9/5044

(57) ABSTRACT

Embodiments of the present disclosure relate to a method, an electronic device, and a program product for allocating resources. A method for allocating resources includes determining multiple resource consumption degrees of multiple input/output (I/O) modes of a first processing node. The method further includes determining a first load of the first processing node based on the multiple resource consumption degrees and I/O counts for the multiple I/O modes; and allocating a storage object in the first processing node to a second processing node based on the first load. By means of the method, in some embodiments, dynamic Asymmetric Logical Unit Access (ALUA) based on I/O modes is realized, and differences in resource consumption among different I/O modes are considered to generate dynamic ALUA migration guidelines, ultimately improving the accuracy of dynamic ALUA balancing.

### RELATED APPLICATION

The present application claims priority to Chinese Patent Application No. 202311325126.1, filed Oct. 12, 2023, and entitled “Method, Electronic Device, and Program Product for Allocating Resources,” which is incorporated by reference herein in its entirety.

### FIELD

Embodiments of the present disclosure relate to the field of computers, and more specifically, to a method, an electronic device, and a computer program product for allocating resources.

### BACKGROUND

Asymmetric Logical Unit Access (ALUA) is an industry standard protocol that can be used to identify optimized paths between a storage system and a host. ALUA supports querying path attributes from an initiator to a target, such as a primary path, a secondary path, an active optimization path, and an active non-optimization path. It also allows the target to transmit events back to the initiator, thereby allowing for the development of multipath software to support any storage array.

### SUMMARY

Embodiments of the present disclosure relate to a method, an electronic device, and a computer program product for allocating resources.

According to a first aspect of the present disclosure, a method for allocating resources is provided. The method includes determining multiple resource consumption degrees of multiple input/output (I/O) modes of a first processing node. The method further includes determining a first load of the first processing node based on the multiple resource consumption degrees and I/O counts for the multiple I/O modes, and allocating a storage object in the first processing node to a second processing node based on the first load, where the storage object is used to store data in an I/O operation.

According to a second aspect of the present disclosure, an electronic device for allocating resources is provided. The electronic device includes at least one processor, and a memory coupled to the at least one processor and having instructions stored therein, wherein the instructions, when executed by the at least one processor, cause the electronic device to perform actions comprising: determining multiple resource consumption degrees of multiple I/O modes of a first processing node. The actions further include determining a first load of the first processing node based on the multiple resource consumption degrees and I/O counts for the multiple I/O modes, and allocating a storage object in the first processing node to a second processing node based on the first load, where the storage object is used to store data in an I/O operation.

According to a third aspect of the present disclosure, a computer program product is provided. The computer program product is tangibly stored on a non-transitory computer-readable medium and comprises machine-executable instructions, wherein the machine-executable instructions, when executed by a machine, cause the machine to perform steps of the method in the first aspect of the present disclosure.

### BRIEF DESCRIPTION OF THE DRAWINGS

By description of example embodiments of the present disclosure, provided in more detail herein with reference to the accompanying drawings, the above and other objectives, features, and advantages of the present disclosure will become more apparent. In the example embodiments of the present disclosure, the same reference numerals generally represent the same elements.

FIG. 1 shows a schematic diagram of an example storage system in which a device and/or a method of embodiments of the present disclosure can be implemented.

FIG. 2 shows a flow chart of a method for allocating resources according to an embodiment of the present disclosure;

FIG. 3 shows a flow chart of a method for dynamically combining I/O resource consumption degrees with dynamic ALUA according to some embodiments of the present disclosure;

FIG. 4 shows an experimental results diagram of resource consumption degrees in different I/O modes; and

FIG. 5 is a block diagram of an example device that can be used to implement an embodiment of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

Dynamic ALUA is implemented for load balancing of storage objects between processing nodes in a storage system, and its value lies in solving bottlenecks and optimizing resource utilization such as computing and bandwidth resources. Currently, the dynamic ALUA mainly considers input/output (I/O) (“input and/or output”) counts when balancing between the processing nodes, because these I/O counts distinguish between read and write I/Os. The dynamic ALUA can also balance resource utilization of the processing nodes by balancing external host I/Os. But that's not enough. For I/O access, in addition to read or write operations, there are also factors such as I/O modes, for example, the I/O size and random or sequential I/Os.

Statistics generated by the dynamic ALUA based merely on processing node I/Os are not accurate, and the current ALUA may also consider some factors related to read or write operations, such as balancing read and write counts in processing nodes, but it still cannot accurately describe different I/O modes because I/O modes not only include read and write, but also I/O sizes, as well as sequential or random access modes. There are usually different I/O modes for different applications or businesses. In addition, storage workloads have I/O characteristics. Therefore, in order to analyze and adjust performance, it is also necessary to understand the workload generated by an application and/or host. These I/O characteristics can include I/O size, read/write ratio, random I/O to sequential I/O ratio, and so on.

To solve at least the above and other potential problems, an embodiment of the present disclosure provides a method for allocating resources. The method includes determining multiple resource consumption degrees of multiple I/O modes of a first processing node. The method further includes determining a first load of the first processing node based on the multiple resource consumption degrees and I/O counts for the multiple I/O modes; and allocating a storage object in the first processing node to a second processing node based on the first load, where the storage object is used to store data in an I/O operation.

By means of the method implemented in the present disclosure, a dynamic ALUA based on I/O modes is realized, and differences in resource consumption among different I/O modes are considered. The method implemented in the present disclosure can be used to measure the resource consumption degrees of the I/O modes, and then combine I/O counts with the resource consumption degrees of the I/O modes to generate dynamic ALUA relocation guidelines, ultimately improving the accuracy of dynamic ALUA balancing.

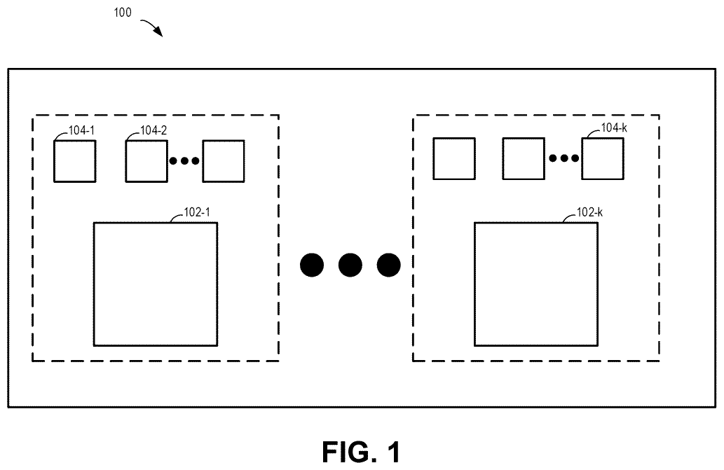

Fundamental principles and several example embodiments of the present disclosure will be described in detail below with reference to the accompanying drawings. FIG. 1 shows a schematic diagram of a storage system 100 according to an embodiment of the present disclosure. It should be understood that the number and arrangement of processing nodes, objects, components, and elements shown in FIG. 1 are only examples, and the schematic diagram may include components, elements, processing nodes, objects, and various additional elements with different numbers and arrangements. It should also be understood that although storage system 100, as an example in the present disclosure, is a storage system based on dynamic ALUA, the method implemented based on the present disclosure can also be applied to a system based on any architecture or system.

As shown in FIG. 1, in storage system 100 based on dynamic ALUA, one or more processing nodes 102-1 to 102-k may be included, and the processing nodes 102-1 to 102-k may be used to process all I/O requests or operations from a user or a client. According to embodiments of the present disclosure, “processing nodes” in the storage system may refer to basic units forming a storage system. These processing nodes can be hardware devices, servers, storage arrays, etc., collaborating together to provide data storage and access services. Each processing node typically has its own processing power, storage resources, and network connectivity. Different storage systems can have different processing node designs and functions.

In some embodiments, the processing node 102-1 can be a primary processing node and responsible for processing all I/O requests, and the processing node 102-k can be a secondary processing node, which is in a standby state. When the primary processing node 102-1 fails, the storage system 100 can switch to the processing node 102-k to take over processing I/O requests or operations from users or clients. In some embodiments, the processing nodes 102-1 to 102-k can simultaneously process multiple I/O requests or operations from multiple users or multiple clients, which is not limited in the present disclosure.

Each processing node of the processing nodes 102-1 to 102-k may respectively include one or more storage objects 104-1, 104-2, . . . 104-k, etc. The storage objects, which may illustratively comprise respective logic units, can be logical storage areas in the storage system 100, which can be composed of physical hard disks, volumes, or other file systems, and store corresponding I/O data. As an example, in the context where the storage system 100 provides storage space to a client or a host, the methods of providing storage space can include but are not limited to block storage and file storage.

In an embodiment where block storage is used as the storage method, the storage objects 104-1, 104-2 . . . 104-k can be mounted in the form of volumes to the host or client. In an embodiment where file storage is used as the storage method, the storage objects 104-1, 104-2 . . . 104-k can be mounted in a shared form to the host or client. Hence, the storage objects 104-1, 104-2, . . . 104-k can be assigned to one or more hosts or clients, and hosts can access data in the storage system 100 through the storage objects. The storage objects 104-1, 104-2, . . . 104-k can combine the I/O modes in the processing nodes with the I/O counts.

It should also be understood that in the storage system 100, each application can have different I/O modes. Table 1 below summarizes relevant data on the I/O modes of some applications:

TABLE 1
I/O modes for different applications

| | | | | Random |
|---|---|---|---|---|
| | | | Read (R)/ | (R)/ |
| | | | Write (W) | Sequence (S) |
| Application | I/O size | | Ratio | Ratio |
| Web File Server | 4 KB/8 KB/ | | 95% R/5% W | 75% R/25% S |
| | 64 KB | | | |
| Web Server Log | 8 | KB | 100% W | 100% R |
| OS Paging | 64 | KB | 90% R/10% W | 100% S |
| Exchange Server | 4 | KB | 67% R/33% W | 100% R |
| Workstation | 8 | KB | 80% R/20% W | 80% R/20% S |
| Media Stream | 64 | KB | 98% R/2% W | 100% S |
| Online Transaction | 8 | KB | 70% R/30% W | 100% R |

| | | | |
|---|---|---|---|
| Processing | | | |
| (OLTP)-data | | | |
| OLTP - log | 512 bytes | 100% W | 100% R |
| | to 64 KB | | |

As an example, storage system 100 based on dynamic ALUA can be installed in any computing device with processing computing resources or storage resources. For example, the computing device may have common capabilities such as receiving and sending data requests, real-time data analysis, local data storage, and real-time network connection. The computing device may typically include various types of devices. Examples of the computing device may include, but are not limited to, database servers, rack servers, server clusters, blade servers, enterprise servers, application servers, desktop computers, laptops, smartphones, wearable devices, security devices, intelligent manufacturing devices, smart home devices, Internet of Things devices, smart cars, drones, and so on, which are not limited in the present disclosure.

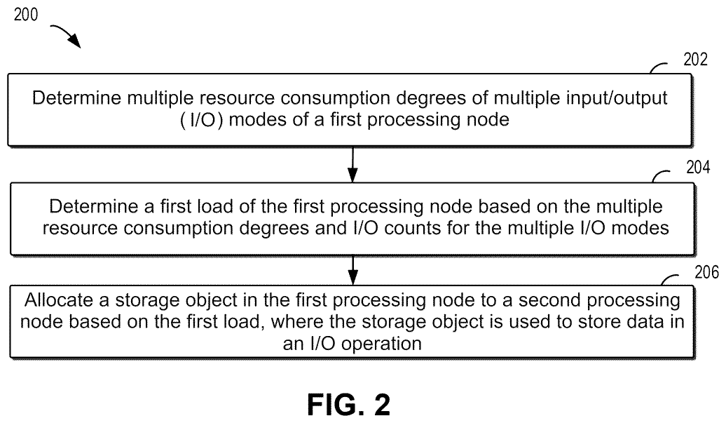

A schematic diagram of an architecture of a storage system in which a method and/or a process according to an embodiment of the present disclosure can be implemented have been described with reference to FIG. 1 above. A flow chart of a method 200 for allocating resources according to embodiments of the present disclosure will be described below in conjunction with FIG. 2. In accordance with the above description regarding the storage system 100, the method 200 for allocating resources according to embodiments of the present disclosure can be executed, for example, at edge devices with computing capabilities, and/or at cloud servers, and such arrangements are not limited in the present disclosure. To improve accuracy of load balancing of a storage system, the method 200 for allocating resources according to an embodiment of the present disclosure is provided.

At block 202, multiple resource consumption degrees of multiple I/O modes of a first processing node are determined. As an example, the storage system 100 can determine resource consumption degrees of a processing node 102-1 in different I/O modes. Depending on different applications being processed by the processing node 102-1, the processing node can be in different I/O modes. For example, in some I/O modes of processing media streams, the processing node 102-1 can have an I/O size of 64 KB, a read/write ratio of 98% R/2% W, and 100% sequential writing. However, in an I/O mode of processing the online transaction processing (OLTP)-log, the processing node 102-1 can have an I/O size of 512 bytes to 64 KB, a read/write ratio of 100% W, and 100% random write. Therefore, when dealing with different tasks, the storage system resources consumed by different I/O modes can have significant differences.

As an example, in embodiments of the present disclosure, a CPU utilization rate consumed for each I/O operation in each I/O mode of multiple I/O modes by the processing node 102-1 can be calculated, and a bandwidth usage amount consumed for each I/O operation in each I/O mode of the multiple I/O modes can be calculated. Based on factors such as the usage conditions and configurations of the storage system 100, different weights are assigned to the CPU utilization rate and the bandwidth usage amount, and the two are combined to obtain a resource consumption degree in a specific I/O mode. Additionally or alternatively, in some embodiments, the resource consumption degrees in I/O modes can also be determined based on an I/O size, a read-to-write ratio, a random I/O to sequential I/O ratio, which is not limited in the present disclosure.

At block 204, a first load of the first processing node is determined based on the multiple resource consumption degrees and I/O counts for the multiple I/O modes. As an example, the storage system 100 can determine a corresponding load of the processing node 102-1 based on different resource consumption degrees and corresponding I/O counts for different I/O modes. For example, the storage system 100 can determine average input/output operations per second (IOPS) of one or more storage objects 104-1, 104-2, and so on in the processing node 102-1.

The storage system 100 can then determine, based on the IOPS, I/O counts of the one or more storage objects 104-1, 104-2, and so on in each different I/O mode of the multiple I/O modes in a predetermined time period, and accumulate these I/O counts so as to obtain a total I/O count for each storage object in the multiple storage objects 104-1, 104-2, and so on.

The predetermined time period can be set by the storage system 100 according to factors such as usage conditions and configurations or can be determined by a user, which is not limited in the present disclosure. The total I/O count for the storage object can be combined with the resource consumption degrees for the I/O modes, so as to obtain a total load for each storage object. Finally, the total loads of, for example, the storage objects 104-1, 104-2, and so on in the processing node 102-1 are accumulated to obtain a processing node total load for the processing node 102-1.

At block 206, a storage object in the first processing node is allocated to a second processing node based on the first load, where the storage object is used to store data in an I/O operation. The storage system 100 can calculate the processing node total load of each processing node in a system, and then the storage system 100 can calculate an average load and a standard deviation of the processing nodes 102-1 to 102-k based on the processing node total loads of these processing nodes.

Additionally or alternatively, the storage system 100 can also calculate an imbalance rate of the processing nodes 102-1 to 102-k based on the average load and the standard deviation, and compare the imbalance rate with a predetermined threshold. The predetermined threshold can be set by the storage system 100 according to factors such as usage conditions and configurations, or can be determined by a user, which is not limited in the present disclosure. If the imbalance rate is less than the predetermined threshold, it indicates that the processing node loads of the processing nodes 102-1 to 102-k in the current storage system 100 are balanced. Therefore, there is no need to move or allocate one or more storage objects in the processing nodes 102-1 to 102-k.

On the contrary, if the imbalance rate is greater than or equal to the predetermined threshold, it indicates that the processing node loads of one or more processing nodes of the processing nodes 102-1 to 102-k in the current storage system 100 are unbalanced. Therefore, one or more storage objects in the processing nodes 102-1 to 102-k need to be moved or allocated to another processing node.

For example, if the current processing node 102-1 has the highest processing node load while the second processing node or the processing node 102-k has the lowest processing node load, the storage system 100 can use the processing node 102-1 as a source processing node and use the processing node 102-k as a destination processing node. Then, the storage system 100 can migrate or allocate the storage object having the highest load in the source processing node to the destination processing node as a target, and then recalculate the processing node loads for the processing nodes. If the processing node load of the source processing node is still greater than the processing node load of the destination processing node, the storage object having the highest load in the current source processing node can be allocated to the destination processing node. The process can be repeated until the processing node load of the source processing node is less than or equal to the processing node load of the destination processing node, and the reallocation or migration operation can be rolled back or revoked, thereby achieving guidance of new allocation or migration of the storage objects of the storage system.

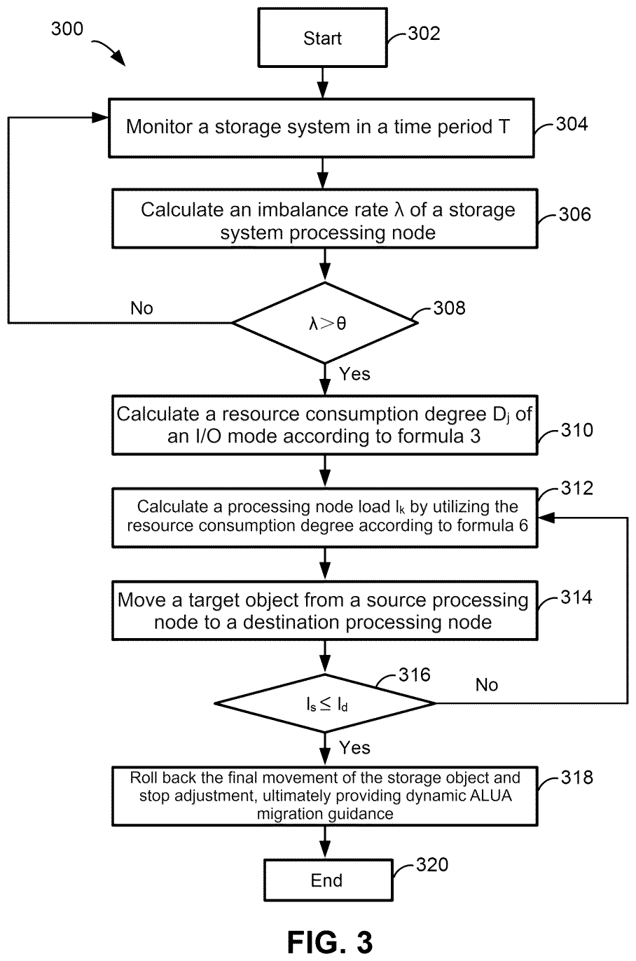

FIG. 3 shows a flow chart of a method 300 of dynamically combining I/O resource consumption degrees with dynamic ALUA according to some embodiments of the present disclosure. It should be understood that the method 300 may also include any additional steps or omit part of the steps shown in FIG. 3, which is not limited in the present disclosure.

At block 302, an ALUA-based storage system can start receiving an I/O operation request from a client or a host. At block 304, the storage system can be monitored within a predetermined time period T to acquire data relevant to the storage system, for example, including but not limited to IOPS Iⱼ in an I/O mode Pⱼ, a CPU utilization rate, a bandwidth usage amount, and other data.

At block 306, an imbalance rate A of (multiple) processing nodes in the current storage system can be determined based on the monitored data. A calculation process regarding the imbalance rate λ will be described in detail below with reference to block 314. At block 308, it can be judged whether the current imbalance rate λ is greater than a predetermined threshold θ for unbalanced loads in the processing nodes. If the imbalance rate is less than the predetermined threshold, i.e., Δ<θ, it indicates that the current processing node loads are balanced. Then, return to block 304 and continue to monitor the storage system state. If the imbalance rate is greater than the predetermined threshold, i.e., λ>θ, it indicates that the processing node loads in the storage system are unbalanced. Therefore, the storage objects need to be reallocated to other processing nodes.

At block 310, resource consumption degrees Dⱼ of (multiple) I/O modes can be first calculated. As an example, the CPU utilization rate and the bandwidth resource usage amount can be used to measure the I/O resource consumption degree in embodiments of the present disclosure. For example, in the time period T, an average IOPS for the I/O mode Pⱼ is Iⱼ, the CPU utilization rate is CPUⱼ, the bandwidth usage/consumption amount is Bⱼ, then the CPU utilization rate of each I/O is

$${C}_{j \_ io} = \frac{{C}_{j}}{{I}_{j}} ,$$

and the bandwidth usage amount of each I/O is

$${B}_{j \_ io} = \frac{{B}_{j}}{{I}_{j}} .$$

Pⱼ represents a specific I/O mode, where 0≤j≤J, and J represents a total number of I/O modes in the storage system. Cⱼ represents the CPU resource consumption degree of the mode Pⱼ.

Since the CPU and the bandwidth have different units, the resource consumption degrees in/modes can first be normalized as below:

$${NC}_{j \_ io} = \frac{{C}_{j \_ io}}{{\sum }_{j = 1}^{J} {C}_{j \_ io}} \qquad ( 1 )$$

$${NB}_{j \_ io} = \frac{{B}_{j \_ io}}{{\sum }_{j = 1}^{J} {B}_{j \_ io}} \qquad ( 2 )$$

Then, the CPU utilization rates and the bandwidth resource consumption amounts can be combined with weights W_{C} and W_{B}, so as to calculate resource consumption degrees of (multiple) modes. In an embodiment of the present disclosure, W_{C}+W_{B}=1, and then the following formula 3 can be used to calculate the resource consumption degrees D_{j_io} of the I/O modes Pⱼ:

$${D}_{j \_ io} = {w}_{C} * {NC}_{j \_ io} + {w}_{B} * {NB}_{j \_ io} \qquad ( 3 )$$

Additionally or alternatively, in some embodiments, (multiple) resource consumption degrees of (multiple) I/O modes can be determined based on one or more of the I/O size, the read-to-write ratio, and the random I/O to sequential I/O ratio, which is not limited in the present disclosure.

At block 312, loads of the processing nodes can be calculated by utilizing the resource consumption degrees. According to embodiments of the present disclosure, K processing nodes may exist in the storage system. For each processing node nₖ, the number of storage objects/logical storage units on the processing node nₖ of the storage system can be Nₖ, the storage objects o_{k_i} belong to respective processing nodes, and k≤K, 0≤i≤Nₖ. K is the total number of processing nodes of the storage system, generally K≥2.

Within the monitored time period T, the average IOPS in the time period T can be Iⱼ. For each storage object, multiple I/O modes may exist. According to embodiments of the present disclosure, the I/O count under the mode j can be represented as io_{k_i}, and the I/O count of the storage object o_{k_i} of the mode Pⱼ can be calculated as:

$${io}_{k \_ i} = {I}_{j} * T \qquad ( 4 )$$

The total I/O count of the storage object o_{k_i} can be calculated as: Σⱼ₌₁^{J}io_{k_i}. A total load of the storage object o_{k_i} combining the resource consumption degrees and the I/O counts of (multiple) modes can be calculated as:

$${l}_{k \_ i} = {\sum }_{j = 1}^{J} {io}_{k \_ i} * {D}_{j} \qquad ( 5 )$$

The load lₖ of the processing node nₖ can be Σᵢ₌₁^{N}^{ₖ}Σⱼ₌₁^{J}io_{k_i}*Dⱼ, where lₖ can also be represented by the following formula:

$${l}_{k} = {\sum }_{i = 1}^{{N}_{k}} {l}_{{k}_{i}} = {\sum }_{i = 1}^{{N}_{k}} {\sum }_{j = 1}^{J} {io}_{{k}_{i}} * {D}_{j} = {\sum }_{i = 1}^{{N}_{k}} {\sum }_{j = 1}^{J} {I}_{j} * T * ( {w}_{C} * {NC}_{j \_ io} + {w}_{B} * N {B}_{j \_ io} ) \qquad ( 6 )$$

At block 314, a target storage object can be moved from a source processing node to a destination processing node. Based on the obtained load lₖ of each processing node, the storage system can guide dynamic ALUA to allocate the storage objects. The dynamic ALUA can first measure the load status of each processing node, and then dynamically allocate the storage objects to the processing nodes. Therefore, the storage system can first measure the load imbalance status. In embodiments of the present disclosure, an average load of K processing nodes can be represented as:

$${l}_{average} = \frac{{\sum }_{k = 1}^{K} {l}_{k}}{K} \qquad ( 7 )$$

The standard deviation of the processing node loads can be represented as:

$$σ = \sqrt{\frac{{\sum }_{k = 1}^{K} {( {l}_{k} - {l}_{average} )}^{2}}{K}} \qquad ( 8 )$$

The imbalance rate λ in the processing nodes can be represented as:

$$λ = \frac{σ}{{l}_{average}} \qquad ( 9 )$$

According to some embodiments of the present disclosure, the load imbalance threshold in the multiple processing nodes can be θ. The judgment condition in the above block 308 can be combined to determine whether to move one or more storage objects in a processing node to another processing node.

When the imbalance rate is greater than the predetermined threshold, i.e., λ≥θ, it is determined to move one or more storage objects in the processing node to a second processing node or another processing node. The storage system can choose the highest load processing node with the maximum load l_{k_max} as the source processing node ns, and use the lowest load processing node with the minimum load l_{k_min} as the destination processing node n_{d}. The storage system can subsequently choose, from the source node, an object o_{s_i} with the highest load l_{s_i} as the target to migrate/move from the source processing node ns to the destination processing node n_{d}, and recalculate loads of (multiple) processing nodes. These steps can be iterated and looped, via blocks 316 and 312, until the condition in block 316 is satisfied and the method moves to block 318. Then, at block 318, roll back the previous migration and stop adjusting, ultimately providing ALUA dynamic migration or allocation guidance for the storage object. At block 320, the entire allocation process can end.

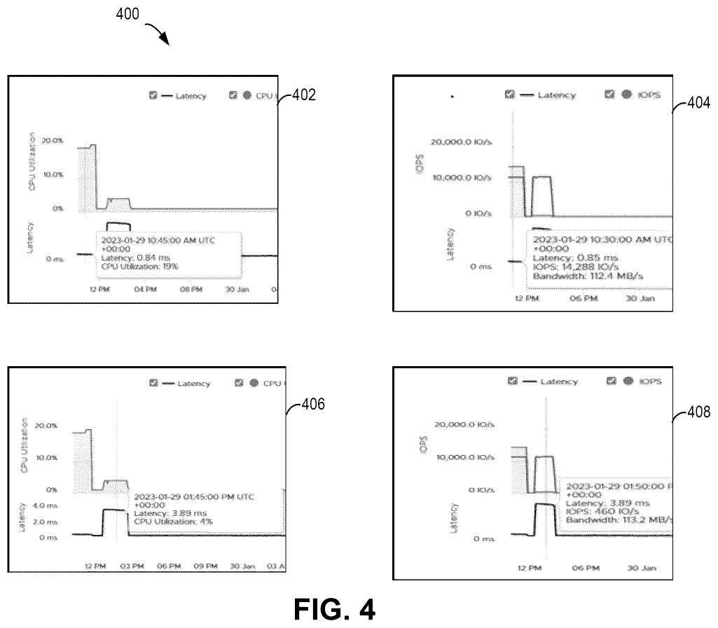

FIG. 4 shows an experimental results diagram 400 of resource consumption degrees in different I/O modes. As shown in FIG. 4, performance metrics between the I/O mode of 8K_100W_100S (the I/O size of 8 KB, 100% write, and 100% sequence) and the I/O mode of 256K_100W_100S (the I/O size of 256 KB, 100% write, and 100% sequence) are compared. In the diagram 400, portions 402 and 404 show relevant experimental data in the 8K_100W_100S mode, and portions 406 and 408 show relevant experimental data in the 256K_100W_100S mode. The specific summary results are shown below in Table 2:

TABLE 2
CPU utilization rate and bandwidth usage amount
of each I/O operation of different I/O modes

| | | | | | CPU | Bandwidth |
|---|---|---|---|---|---|---|
| | | | | | Utilization | Usage Amount |
| | Average | | CPU | | Rate of Each | of Each I/O |
| I/O mode | IOPS | Time | usage | Bandwidth | I/O Operation | Operation |
| 8k_100W_100S | 14300/s | 2 Hr | 19% | 112.4 MB/s | 0.0013% | 0.0079 MB/s |
| 256k_100W_100S | 460/s | 2 Hr | 4% | 113.2 MB/s | 0.0087% | 0.2460 MB/s |

The experimental results show that different I/O modes consume different resources. For example, a large I/O size will result in high bandwidth requirements per I/O operation, while a small I/O size mode will result in a high CPU utilization rate. Due to different computational resources being consumed by different I/O modes, the dynamic ALUA algorithm needs to balance the storage objects between the storage processing nodes by combining I/O modes and the I/O counts.

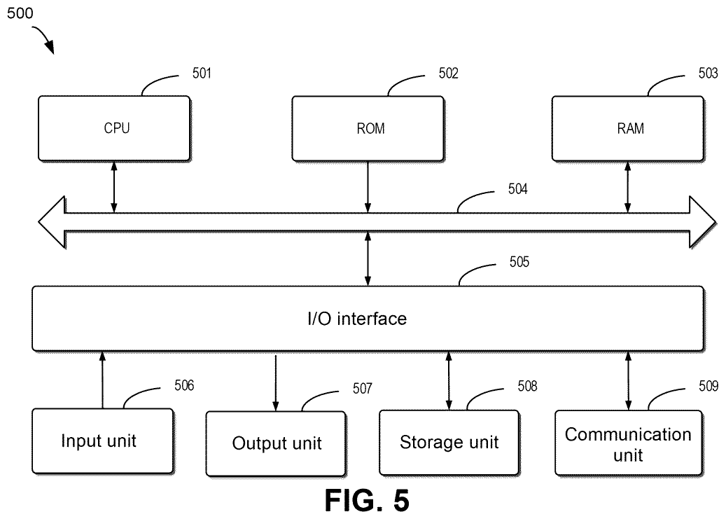

FIG. 5 is a block diagram of an example device 500 that can be used to implement embodiments of the present disclosure. The computing device in FIG. 1 may be implemented using the device 500. As shown in the figure, the device 500 includes a central processing unit (CPU) 501, which may execute various appropriate actions and processing in accordance with computer program instructions stored in a read-only memory (ROM) 502 or computer program instructions loaded from a storage unit 508 onto a random access memory (RAM) 503. Various programs and data required for the operation of the device 500 may also be stored in the RAM 503. The CPU 501, the ROM 502, and the RAM 503 are connected to each other through a bus 504. An I/O interface 505 is also connected to the bus 504.

A plurality of components in the device 500 are connected to the I/O interface 505, including: an input unit 506, such as a keyboard and a mouse; an output unit 507, such as various types of displays and speakers; the storage unit 508, such as a magnetic disk and an optical disc; and a communication unit 509, such as a network card, a modem, and a wireless communication transceiver. The communication unit 509 allows the device 500 to exchange information/data with other devices via a computer network, such as the Internet, and/or various telecommunication networks.

The various processes and processing described above, such as the method 200 and/or the method 300, may be performed by the CPU 501. For example, in some embodiments, the methods 200 and 300 may be implemented as a computer software program that is tangibly contained in a machine-readable medium, such as the storage unit 508. In some embodiments, part of or all the computer program may be loaded and/or installed to the device 500 via the ROM 502 and/or the communication unit 509. When the computer program is loaded to the RAM 503 and executed by the CPU 501, one or more actions of the method 200 and/or the method 300 described above may be executed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, another programmable data processing apparatus, or another device, so that a series of operating steps can be performed on the computer, the other programmable data processing apparatus, or the other device to produce a computer-implemented process, such that the instructions executed on the computer, the other programmable data processing apparatus, or the other device can implement the functions/actions specified in one or more blocks in the flow charts and/or block diagrams.

The flow charts and block diagrams in the drawings illustrate the architectures, functions, and operations of possible implementations of the systems, methods, and computer program products according to a plurality of embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for allocating resources, comprising:
determining multiple resource consumption degrees of multiple input/output (I/O) modes of a first processing node;
determining a first load of the first processing node based on the multiple resource consumption degrees and I/O counts for the multiple I/O modes; and
allocating a storage object in the first processing node to a second processing node based on the first load, wherein the storage object is used to store data in an I/O operation.

2. The method according to claim 1, wherein determining the multiple resource consumption degrees of the multiple I/O modes of the first processing node comprises:
determining a CPU utilization rate consumed by each I/O operation performed in each I/O mode of the multiple I/O modes;
determining a bandwidth usage amount consumed by each I/O operation performed in each I/O mode of the multiple I/O modes; and
combining the CPU utilization rates and the bandwidth usage amounts to determine the multiple resource consumption degrees of the multiple I/O modes.

3. The method according to claim 1, wherein determining the first load of the first processing node based on the multiple resource consumption degrees and the I/O counts for the multiple I/O modes comprises:
determining average input/output operations per second (IOPS) of the storage object in the first processing node;
determining, based on the IOPS, the I/O count of the storage object in each of the multiple I/O modes in a predetermined time period; and
determining a total I/O count for the storage object based on the I/O count in each of the multiple I/O modes.

4. The method according to claim 3, wherein determining the first load of the first processing node based on the multiple resource consumption degrees and the I/O counts for the multiple I/O modes further comprises:
combining the total I/O count for the storage object and the multiple resource consumption degrees for the multiple I/O modes to determine a total load for the storage object; and
determining the first load of the first processing node based on the total load for the storage object.

5. The method according to claim 1, wherein allocating the storage object in the first processing node to the second processing node based on the first load comprises:
determining an imbalance rate based on an average load and a standard deviation between the first load and a second load of the second processing node; and
comparing the imbalance rate with a predetermined threshold.

6. The method according to claim 5, wherein comparing the imbalance rate with the predetermined threshold comprises:
responsive to the imbalance rate being less than the predetermined threshold, monitoring the first load of the first processing node and the second load of the second processing node; and
responsive to the imbalance rate being greater than or equal to the predetermined threshold, allocating the storage object of the first processing node to the second processing node.

7. The method according to claim 5, wherein allocating the storage object in the first processing node to the second processing node further comprises:
allocating a first storage object with the highest load in the first processing node to the second processing node; and
responsive to the first load of the first processing node being still greater than the second load of the second processing node, allocating a second storage object having a second load less than the highest load in the first processing node to the second processing node.

8. The method according to claim 5, wherein allocating the storage object in the first processing node to the second processing node further comprises:
responsive to the first load of the first processing node being less than or equal to the second load of the second processing node, withdrawing an operation of allocating the storage object in the first processing node to the second processing node.

9. The method according to claim 1, wherein the multiple resource consumption degrees of the multiple I/O modes are determined based on I/O sizes, read-to-write ratios, and random I/O to sequential I/O ratios.

10. An electronic device, comprising:
at least one processor; and
a memory, the memory being coupled to the at least one processor and having instructions stored therein, wherein the instructions, when executed by the at least one processor, cause the electronic device to perform actions comprising:
determining multiple resource consumption degrees of multiple input/output (I/O) modes of a first processing node;
determining a first load of the first processing node based on the multiple resource consumption degrees and I/O counts for the multiple I/O modes; and
allocating a storage object in the first processing node to a second processing node based on the first load, wherein the storage object is used to store data in an I/O operation.

11. The electronic device according to claim 10, wherein determining the multiple resource consumption degrees of the multiple I/O modes of the first processing node comprises:
determining a CPU utilization rate consumed by each I/O operation performed in each I/O mode of the multiple I/O modes;
determining a bandwidth usage amount consumed by each I/O operation performed in each I/O mode of the multiple I/O modes; and
combining the CPU utilization rates and the bandwidth usage amounts to determine the multiple resource consumption degrees of the multiple I/O modes.

12. The electronic device according to claim 10, wherein determining the first load of the first processing node based on the multiple resource consumption degrees and the I/O counts for the multiple I/O modes comprises:
determining average input/output operations per second (IOPS) of the storage object in the first processing node;
determining, based on the IOPS, the I/O count of the storage object in each of the multiple I/O modes in a predetermined time period; and
determining a total I/O count for the storage object based on the I/O count in each of the multiple I/O modes.

13. The electronic device according to claim 12, wherein determining the first load of the first processing node based on the multiple resource consumption degrees and the I/O counts for the multiple I/O modes further comprises:
combining the total I/O count for the storage object and the multiple resource consumption degrees for the multiple I/O modes to determine a total load for the storage object; and
determining the first load of the first processing node based on the total load for the storage object.

14. The electronic device according to claim 10, wherein allocating the storage object in the first processing node to the second processing node based on the first load comprises:
determining an imbalance rate based on an average load and a standard deviation between the first load and a second load of the second processing node; and
comparing the imbalance rate with a predetermined threshold.

15. The electronic device according to claim 14, wherein comparing the imbalance rate with the predetermined threshold comprises:
responsive to the imbalance rate being less than the predetermined threshold, monitoring the first load of the first processing node and the second load of the second processing node; and
responsive to the imbalance rate being greater than or equal to the predetermined threshold, allocating the storage object of the first processing node to the second processing node.

16. The electronic device according to claim 14, wherein allocating the storage object in the first processing node to the second processing node further comprises:
allocating a first storage object with the highest load in the first processing node to the second processing node; and
responsive to the first load of the first processing node being still greater than the second load of the second processing node, allocating a second storage object having a second load less than the highest load in the first processing node to the second processing node.

17. The electronic device according to claim 14, wherein allocating the storage object in the first processing node to the second processing node further comprises:
responsive to the first load of the first processing node being less than or equal to the second load of the second processing node, withdrawing an operation of allocating the storage object in the first processing node to the second processing node.

18. The electronic device according to claim 10, wherein the multiple resource consumption degrees of the multiple I/O modes are determined based on I/O sizes, read-to-write ratios, and random I/O to sequential I/O ratios.

19. A computer program product tangibly stored on a non-transitory computer-readable storage medium and comprising machine-executable instructions, wherein the machine-executable instructions, when executed by a machine, cause the machine to perform actions comprising:
determining multiple resource consumption degrees of multiple input/output (I/O) modes of a first processing node;
determining a first load of the first processing node based on the multiple resource consumption degrees and I/O counts for the multiple I/O modes; and
allocating a storage object in the first processing node to a second processing node based on the first load, wherein the storage object is used to store data in an I/O operation.

20. The computer program product according to claim 19, wherein determining the multiple resource consumption degrees of the multiple I/O modes of the first processing node comprises:
determining a CPU utilization rate consumed by each I/O operation performed in each I/O mode of the multiple I/O modes;
determining a bandwidth usage amount consumed by each I/O operation performed in each I/O mode of the multiple I/O modes; and
combining the CPU utilization rates and the bandwidth usage amounts to determine the multiple resource consumption degrees of the multiple I/O modes.
